(19) United States
(12) Patent Application Publication
(10) Pub. No.: US 2018/0077776 A1
(43) Pub. Date: Mar. 15, 2018

(54) LED COMPENSATION SYSTEM AND CONTROL METHOD THEREOF

(71) Applicants: Hyundai Motor Company, Seoul (KR); Kia Motors Corporation, Seoul (KR)

(72) Inventors: Jong Min PARK, Seoul (KR); Nak Kyoung KONG, Seongnam-si (KR); Ki Hong LEE, Seoul (KR); Kyu Geol LEE, Seongnam-si (KR); Keon Soo JIN, Ulsan (KR); Keun Sig LIM, Yongin-si (KR); Yong Pyo HONG, Bongdong-eup (KR); Nam Joon YOO, Bongdong-eup (KR)

(73) Assignees: Hyundai Motor Company, Seoul (KR); Kia Motors Corporation, Seoul (KR)

(21) Appl. No.: 15/385,666

(22) Filed: Dec. 20, 2016

(30) Foreign Application Priority Data
Sep. 13, 2016 (KR) 10-2016-0117953

(51) Int. Cl. H05B 37/02; H05B 33/08; H05B 37/03

(52) U.S. Cl. CPC H05B 37/0227; H05B 37/03; H05B 33/089; H05B 33/0842

(57) ABSTRACT

An LED compensation system and a method of controlling the system are provided, wherein in the system, when errors occur in some of a plurality of LED members included in an LED package, an adjacent LED device is substituted for the LED device having the error and performs the same function.

### CROSS-REFERENCE TO RELATED APPLICATION

The present application claims priority to Korean Patent Application No. 10-2016-0117953, filed on Sep. 13, 2016, the entire contents of which is incorporated herein for all purposes by this reference.

### BACKGROUND

### Field of the Invention

The present invention relates to an LED compensation system and a control method thereof. More particularly, it relates to an LED compensation system and a control method thereof, intended to compensate for a functional deterioration of each LED device in a configuration in which a package including a plurality of LED members is formed and a light emitting operation and a light receiving operation are simultaneously performed via the LED members, thus continuously keeping the amount of light over a reference value.

### Description of Related Art

A Light Emitting Diode (hereinafter referred to as “LED”) is a device that emits light when an electron meets a hole at a P-N junction by applying an electric current. An LED illumination system is much lower in power consumption than a conventional illumination system. That is, this LED illumination system may emit light of the same brightness as the conventional illumination system by using power that is one-tenth of that of an incandescent lamp or one-half of that of a fluorescent lamp. Further, the service life of the incandescent lamp is only 1,000 to 4,000 hours, whereas the service life of the LED is 50,000 to 100,000 hours. As such, the life of the LED is much longer. Since the LED illumination system incurs low cost for replacement and maintenance, it is suitable for a place requiring high replacement cost, for example, an outer wall of a building, an indoor swimming pool, or a street light. Moreover, the LED illumination system generates little heat, so that it is never hot when a person touches the system, unlike the incandescent lamp or the fluorescent lamp.

Further, the LED has a small size, so that 32 LED members each having the size of 1 mm or less may emit light equivalent to the fluorescent lamp and thus the LED illumination system is suitable for a portable purpose. The LED illumination system is not frangible, so that it is easy to use for a dome light, a fog light and a headlight of a vehicle or the like. Furthermore, the LED illumination system does not need to use heavy metal including mercury or the like as in the fluorescent lamp, so that the system is environmentally friendly. Particularly, the LED illumination system may create various lighting effects by controlling a flickering order, a light emitting color or brightness of a plurality of LEDs.

The LED having the above-mentioned advantages is an alternative light source that is currently available for many fields and appeals to people. Recently, an LED package is manufactured to include a plurality of LED members on a printed circuit board.

However, the conventional LED package including the plurality of LED members is problematic in that the failure of only one LED device leads to the performance deterioration of the LED package, so that the entire package should be replaced with a new one in spite of the failure of only one LED device.

FIG. 1 illustrates an LED sensor including three LED packages. Here, both LED1 (11) and LED3 (13) or both LED2 (12) and LED3 (13) simultaneously emit light.

That is, if LED3 (13) is damaged, the entire LED package should be replaced with a new one even when LED1 (11) and LED2 (12) have no functional problem.

Further, Korean Patent Laid-Open Publication No. 10-2011-0084731 discloses a backlight unit having a plurality of light source strings. However, the cited document discloses only a configuration for detecting whether there is an error, but does not propose a solution for compensating for errors occurring in some of the light source strings. Therefore, the above-mentioned problem where the entire backlight unit should be replaced with a new one still remains.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a compensation system, in which, when errors occur in some of a plurality of LED members included in an LED package, an adjacent LED device is substituted for the LED device having the error and performs the same function.

Various aspects of the present invention are directed to providing an LED package, in which, even when a functional deterioration occurs in some of a plurality of LED members, a light emitting operation is performed using an adjacent LED device, thus continuously maintaining performance to satisfy a user's demand.

Objects of the present invention are not limited to the above-described objects, other objects of the present invention may be understood by the following description, and become more apparent to those skilled in the art by reading embodiments of the present invention. Further, the objects of the present invention may be realized by means described in claims and a combination thereof.

Various aspects of the present invention are directed to providing an LED compensation system including an LED device including a plurality of LED members to which an electric current is supplied from a power source; a switch located between the power source and the LED device to optionally supply the electric current to each of the LED members; and a control device configured to control an operation of the LED device, wherein at least one LED member of the LED device is operated as a light emitting part, and at least one of remaining LED members is operated as a light receiving part, the light receiving part measures a quantity of light generated from the light emitting part and transmits a light-quantity signal to the control device, and the control device compares the measured light-quantity signal with a predetermined reference value, and the control device performs control to convert at least one LED member that is not used as the light emitting part into the light emitting part, when the light-quantity signal measured by the light receiving part is smaller than the predetermined reference value.

In an exemplary embodiment, the control device may include an analog processing integrated circuit and an MCU, the analog processing integrated circuit may control an operation of the LED device in response to the light-quantity signal measured by the light receiving part, and the MCU may be connected to the analog processing integrated circuit to compare the light-quantity signal received by the light receiving part with the predetermined reference value and transmit an operation control command of the LED device to the analog processing integrated circuit.

In another exemplary embodiment, the MCU may control opening or closing of the switch to convert the LED member that is not used as the light emitting part into the light emitting part, when the measured light-quantity signal is smaller than the predetermined reference value.

In still another exemplary embodiment, the light-quantity signal measured by the light receiving part may be determined by a difference between a voltage applied from the power source and a voltage used in the LED member used as the light emitting part.

In yet another exemplary embodiment, the control device may convert the LED member used as the light emitting part into the light receiving part, when the light-quantity signal measured by the light receiving part is smaller than the predetermined reference value.

In still yet another exemplary embodiment, when two or more LED members form the light emitting part, a sum of light-quantity signals generated by the plurality of LED members constituting the light emitting part may be compared with the predetermined reference value.

In a further exemplary embodiment, when each of LEDs constituting the LED device has a light-quantity signal that is smaller than the predetermined reference value in the control device, the light emitting part may include a plurality of LED members to have a light-quantity signal that is equal to or larger than the predetermined reference value.

In another further exemplary embodiment, the LED compensation system may further include a cover device provided on a top of the LED device to perform uniform scattering.

In still another further exemplary embodiment, the cover device may be configured to have a dome shape.

Various aspects of the present invention are directed to providing a method of controlling an LED compensation system, including a) measuring a quantity of light generated from at least one LED member among a plurality of LED members that is driven as a light emitting part, in the LED member driven as a light receiving part; b) comparing a measured light-quantity signal with a predetermined reference value in a control device; and c) converting at least one LED member that is not used as the light emitting part into the light emitting part, when the light-quantity signal measured at b) is smaller than the predetermined reference value in the control device.

In an exemplary embodiment, at a), the light-quantity signal measured in the light receiving part may be equal to a difference between a voltage applied from a power source and a voltage used in the LED member used as the light emitting part.

In another exemplary embodiment, at c), the converting may include controlling opening or closing of a switch connected to each of the LED members, and converting at least one LED member that is not used as the light emitting part into the light emitting part.

In still another exemplary embodiment, at c), the converting may further include using the LED member that is used as the light emitting part, as the light receiving part.

In yet another exemplary embodiment, at a), when two or more LED members are used as the light emitting part, a sum of light-quantity signals generated by two or more LED members constituting the light emitting part may be compared with the predetermined reference value.

In still yet another exemplary embodiment, at c), when each of the LED members has a light-quantity signal that is smaller than the predetermined reference value in the control device, a plurality of LED members may be provided to have a light-quantity signal that is equal to or larger than the predetermined reference value, thus constituting the light emitting part.

Other aspects and exemplary embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a conventional LED package including three LED members;

FIG. 2 is a view illustrating an LED package including two LED members, as an exemplary embodiment of an LED compensation system of the present invention;

FIG. 3 is a view illustrating a configuration of a control device, as an exemplary embodiment of the LED compensation system of the present invention;

FIG. 4 is a view illustrating a configuration of a control device, as an exemplary embodiment of the LED compensation system of the present invention;

FIG. 5 is a view illustrating an arrangement of three LED members on the LED package, as an exemplary embodiment of the LED compensation system of the present invention;

FIG. 6 is a sectional view of the LED package, as an exemplary embodiment of the LED compensation system of the present invention; and

FIG. 7 is a flowchart illustrating a method of controlling an LED compensation system according to an exemplary embodiment of the present invention.

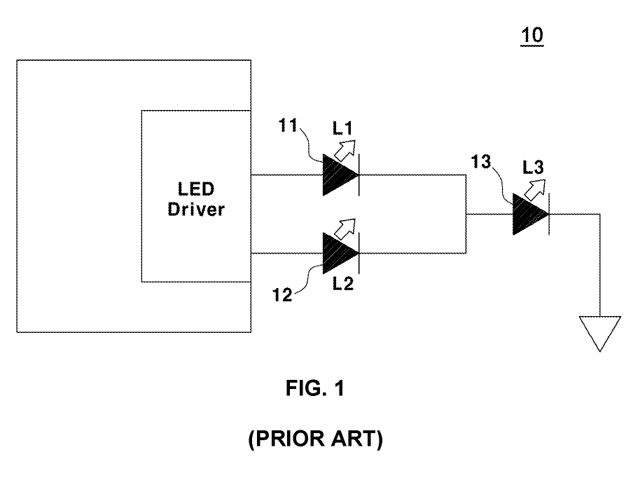

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Further, the term “part”, “package”, etc. described herein means a device for processing at least one function or operation. This may be implemented by hardware, software or a combination of the hardware and the software.

Further, in the following detailed description, names of constituents, which are in the same relationship, are divided into “the first”, “the second”, etc., but the present invention is not necessarily limited to the order in the following description.

A life time of an LED device means a point when an output of the LED device is reduced up to 50%. Thus, in the case of the LED device having the output less than 50%, the LED device does not provide light emitting performance to satisfy a user's demand.

Moreover, a dome light, a rear light and a headlight of a vehicle may include a plurality of LED packages. A rain sensor attached to a windshield of the vehicle is intended to measure a quantity of rainwater depending on an intensity of light generated through the LED device constituting the light emitting part, and the LED package is used for various components.

Accordingly, since the LED device attached to the vehicle is provided at an intensive location to which a high electric current may be applied and is used at high internal temperature, this LED device is relatively shorter in life time than a common LED device.

In the conventional LED package, even when some of a plurality of LED members undergoes a failure, the performance of the entire LED package deteriorates. Therefore, there is a need for an LED package that maintains constant performance even when an individual LED device undergoes a failure.

In an LED compensation system and a method of controlling the system according to an exemplary embodiment of the present invention, an LED package 100 having a plurality of LED members 110 arranged on a substrate is provided and configured to keep the light emitting function of the LED members 110 constant. To this end, some of the LED members 110 constituting the LED package 100 are used as a light emitting part, while others are used as a light receiving part.

The LED compensation system of the present invention includes a power source 120 to supply an electric current to the LED members 110, and an LED device 111 having at least two LED members 110. The LED device 111 has at least one LED member 110 constituting the light emitting part and at least one LED member 110 constituting the light receiving part.

Moreover, a switch 130 is provided to set the function of each LED device 110, is located between the power source 120 and each LED device 110 and is opened or closed to optionally connect the power source 120 with each LED device 110.

The opening or closing of the switch 130 is controlled by the control device 200. When the switch 130 is on, the electric current is applied from the power source 120 to the LED device 110, so that the connected LED device 110 forms the light emitting part.

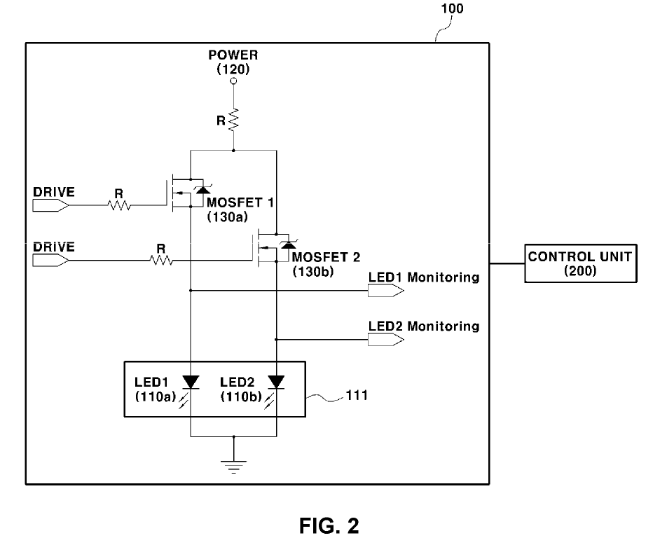

FIG. 2 illustrates an LED compensation system including two LED members 110 according to an exemplary embodiment of the present invention.

The two LED members 110 are connected in parallel to each other, with the power source 120 being connected to an end portion of the LED members. Further, the switch 130 is provided between the power source 120 and each LED device 110. The switch 130 is connected with a control device 200 to be opened or closed. The switch 130 may comprise a Mosfet switch 130 as well as several switching devices that are used in electric circuits including a diode, a zener diode, an IGBT (Insulated Gate Bipolar Transistor), or a thyristor.

In an exemplary embodiment of the present invention, an LED1 member 110a functions as the light emitting part, and an LED2 member 110b functions as the light receiving part. The LED1 member 110a is configured to emit light depending on a predetermined pulse applied from the control device 200. The light emitting operation of the LED1 member 110a may be performed by performing a regular Pulse Width Modulation (PWM) control in an analog processing integrated circuit 210 of the control device 200.

Since the LED2 member 110b functions as the light receiving part, this may measure a quantity of light generated by the LED1 member 110a and may be connected to transmit the measured light-quantity signal to a micro controller unit (hereinafter referred to as an MCU) 220.

The light-quantity signal of the present invention is determined by a difference between a voltage applied from the power source 120 and a voltage used in the LED device 110 used as the light emitting part.

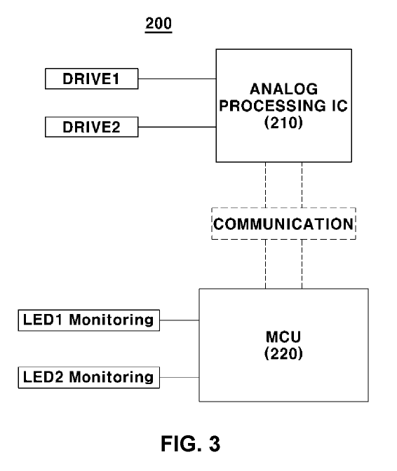

FIG. 3 illustrates an LED compensation system including the control device 200 connected with two LED members 110, to an exemplary embodiment of the present invention.

As illustrated in FIG. 2, the two LED members 110 form the light emitting part and the light receiving part, and are connected with the control device 200. Thus, the light-quantity signal measured by the LED device 110 constituting the light receiving part is connected through an LED monitoring terminal to the MCU 220, and the MCU 220 receives the light-quantity signal.

Further, the control device 200 of the present invention includes an analog processing integrated circuit 210 that is connected with the MCU 220. The analog processing integrated circuit 210 is connected with the switch 130 to apply an electric current between the LED device 110 and the power source 120 via each drive.

Moreover, the analog processing integrated circuit 210 is configured to perform a regular PWM control of power applied from the power source 120 to each LED device 110, thus controlling the light emitting performance of the LED device 110 that forms the light emitting part.

The MCU 220 compares the received light-quantity signal with a predetermined reference value. When the light-quantity signal received from the LED device 110 constituting the light emitting part to the light receiving part is smaller than the predetermined reference value, a control command is executed to turn off the switch 130 of the LED device 110 constituting the light emitting part and turn on the switch 130 so that the LED device 110 that has not performed the function of the light emitting part forms the light emitting part.

In contrast, when the LED device 110 that has been used as the light emitting part has a quantity of light that is less than a predetermined reference value, the MCU 220 executes a control command for turning off the switch 130 to disconnect the LED device 110 from the power source 120. When the LED device 110 that has been used as the light emitting part does not satisfy the above-described conditions, it may be used as the light receiving part.

When the MCU 220 executes a control command to turn on or off the switch 130, the switch 130 may be controlled through the analog processing integrated circuit 210 or the state of the switch 130 may be controlled directly by the MCU 220.

That is, in an exemplary embodiment of the present invention, when the LED1 member 110a forms the light emitting part, the LED2 member 110b may form the light receiving part to measure the quantity of light generated by the LED1 member 110a. The LED2 member 110b configured as above transmits the light-quantity signal received depending on the quantity of light of the LED1 member 110a to the MCU 220, and the MCU 220 compares the received light-quantity signal with the predetermined reference value, so that, when the light-quantity signal is less than the predetermined reference value, the control command is executed to turn off the switch 130 of the LED1 member 110a, and in addition, performs control such that the LED2 member 110b except for the LED1 member 110a or at least one of the LED members 110 that are not used as the light emitting part forms the light emitting part.

When it is determined by the MCU 220 that the light-quantity signal generated by the light emitting part is less than the predetermined reference value, the MCU may perform control such that the LED1 member 110a used as the light emitting part is converted into the light receiving part, and the LED2 member 110b used as the light receiving part is converted into the light emitting part.

In other words, when the light-quantity signal of the LED1 member 110a used as the light emitting part is less than the predetermined reference value, at least one of the LED members 110 that have not been used as the light emitting part may form the light emitting part. When a plurality of LED members 110 forms the light emitting part, a sum of the quantities of light generated from the plurality of LED members 110 constituting the light emitting part may be measured as the light-quantity signal.

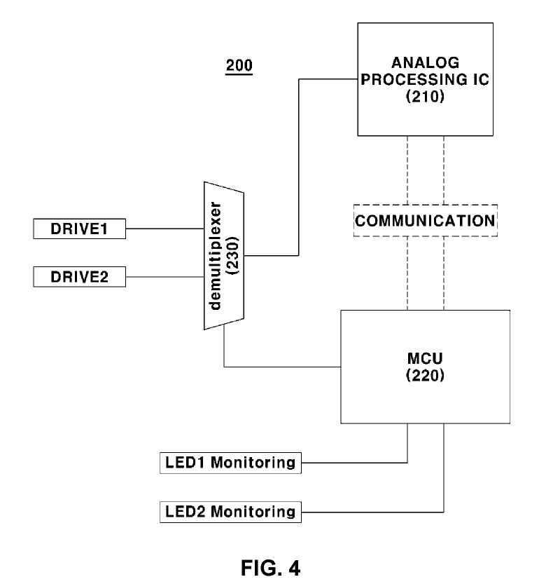

FIG. 4 illustrates the configuration of the control device 200 according to another exemplary embodiment of the present invention.

The control device of FIG. 4 is configured to include the analog processing integrated circuit 210 and the MCU 220 illustrated in FIG. 3. In addition, the analog processing integrated circuit 210 and the MCU 220 are connected to a demultiplex 230. The control device may integrally receive signals input from the analog processing integrated circuit 210 and the MCU 220, and transmit the received control command to each switch 130, thus performing a control operation.

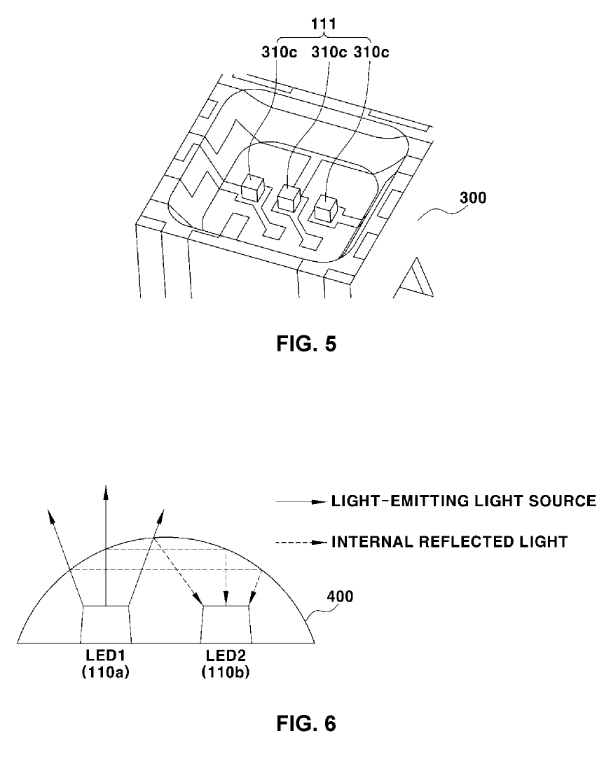

FIG. 5 is a perspective view illustrating the LED compensation system according to an exemplary embodiment of the present invention.

As illustrated in FIG. 5, the LED members connected in parallel to each other are configured in a form of a package, thus forming the integrated circuit placed on the PCB. That is, FIG. 5 illustrates the LED compensation system including three LED members that are connected in parallel to one another, according to the exemplary embodiment of the present invention. The LED1 member 310a forms the light emitting part, and the LED2 member 310b functions as the light receiving part.

When a predetermined electric current is applied from the power source 120 to the LED1 member 310a, the LED1 member 310a emits light and the LED2 member 310b measures the light-quantity signal generated from the LED1 member 310a. The light-quantity signal measured as such is compared with the predetermined reference value. When the light-quantity signal is less than the reference value, the control device 200 turns off the switch 130 of the LED1 member 310a and converts the LED2 member 310b or the LED3 device 310c into the light emitting part. To supply the electric current to a new light emitting part selected in this manner, the control device 200 controls the opening or closing of the switch 130 connected with each LED device 310. Thus, the switch 130 connected to the LED2 member 310b or the LED3 device 310c is converted into an ON state.

In another exemplary embodiment of the present invention, when the light-quantity signal of the LED1 member 310a used as the light emitting part in the LED package 100 including three LED members 310 is less than the predetermined reference value, both the LED2 member 310b and the LED3 device 310c may be set as the light emitting part, and the LED1 member 310a may be set to perform the function of the light receiving part. Further, in the case of measuring the light quantities of two or more LED members 310, the light-quantity signal may be determined by summing up the quantities of light generated from the respective LED members 310.

Moreover, when the light-quantity signal generated from each LED device 310 is less than the predetermined reference value in the control device 200, the switch 130 may be controlled such that LED members 310, except the LED device 310 used as the light receiving part, emit light to obtain the light-quantity signal that is equal to or more than the predetermined reference value. In the configuration including a separate light-quantity sensor, all the LED members 310 constituting the LED device 111 may emit light and the light-quantity signal may be measured.

when the light-quantity signal of each LED device 310 is smaller than the predetermined reference value, the light emitting part may include a plurality of LED members 310 to have a light-quantity signal that is equal to or more than the reference value.

However, when the light-quantity signal does not satisfy the predetermined reference value even when LED members 310, except the LED device 310 used as the light receiving part, are set as the light emitting part, it is determined that the service life of the LED package 100 end portions.

When the respective LED members 310 constituting the LED device 111 do not satisfy the quantity of light that is equal to or more than the predetermined reference value, the switch 130 is controlled such that all the LED members 310 constituting the LED device 111 emit light. When the sum of light quantities of all the LED members 310 is less than the predetermined reference value, an alarm is made to inform of a failure. When all the LED members 310 form the light emitting part, a separate light receiving part may be included.

FIG. 6 is a side sectional view illustrating the LED package 100 including two LED members 110, according to an exemplary embodiment of the present invention.

The LED compensation system of the present invention may further include a cover device 400 located above the LED package 100. The cover device 400 may be configured to protect the LED members 110 and perform the total reflection or surface reflection of the LED members 110 constituting the light emitting part. The reflected light is scattered in the cover device 400.

The reflected light scattered through the cover device 400 configured as such and the light irradiated directly from the light emitting part are incident into the LED device 110 that functions as the light receiving part. Thus, the LED device 110 used as the light receiving part measures the quantity of light through the irradiated light and the reflected light, and transmits the light-quantity signal to the control device 200.

in the exemplary embodiment of the present invention, the dome-shaped cover device 400 is included. Thus, a configuration in which the LED device 110 serving as the light emitting part emits light may include a configuration reflected by the dome-shaped cover device 400 having a predetermined curvature.

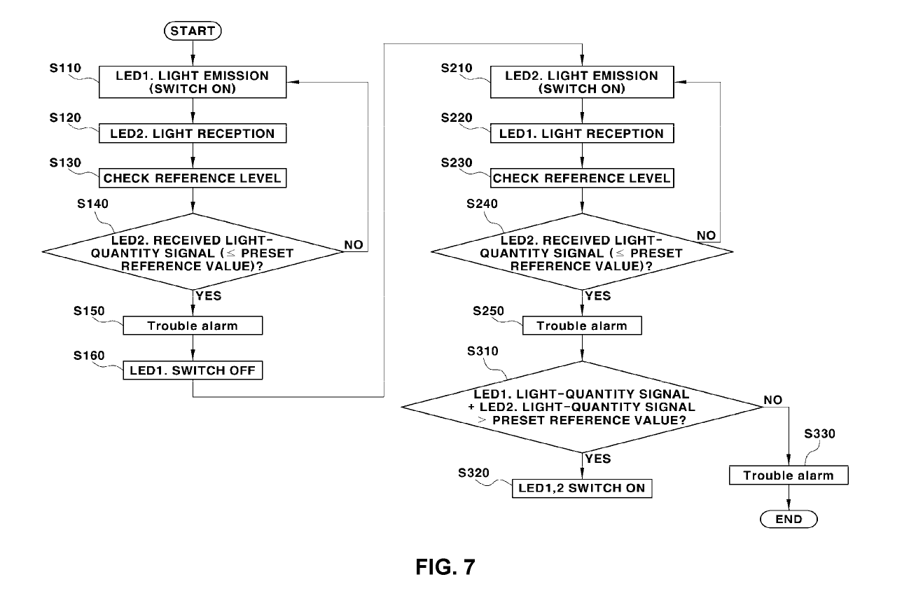

FIG. 7 is a flowchart performed by a controller and illustrating a method of controlling an LED compensation system including two LED members, according to an exemplary embodiment of the present invention.

When power is applied to an initial LED package 100, the switch 130 connected with the LED1 member 110a is converted into an ON state to set the LED1 member 110a as the light emitting part, thus applying power from the power source 120 (S110). Further, to measure the performance of the LED1 member 110a, the LED2 member 110b functions as the light receiving part (S120).

Accordingly, the light emitting part is formed using the LED1 member 110a, and the light receiving part is formed using the LED2 member 110b. After the light emitting part and the light receiving part are formed, the reference level is checked (S130), and the light-quantity signal measured through the light receiving part is compared with the reference value that is predetermined in the control device 200 (S140).

That is, when the measured light-quantity signal is larger than the reference value that is predetermined in the control device 200, the LED1 switch 130 as the light emitting part maintains an ON state. Meanwhile, when the measured light-quantity signal is smaller than the reference value that is predetermined in the control device 200, an alarm informing of a failure is made (S150), and a process of turning off the switch 130 of the LED1 member 110a is performed (S160).

Accordingly, the LED1 member 110a loses a function as the light emitting part through the process of turning off the switch 130 of the LED1 member 110a. Further, a step of turning on the switch 130 of the LED2 member 110b is performed (S210), and a step of converting the LED2 member 110b that is not used as the light emitting part into the light emitting part is performed.

In the case of converting the LED2 member 110b into the light emitting part, the LED1 member 110a that has been previously used as the light emitting part is converted into the light receiving part (S220), and the light quantity of the LED2 member 110b is set to be measured. After the LED2 member 110b forms the light emitting part and the LED1 member 110a forms the light receiving part, a reference level is checked (S230), and the light-quantity signal measured through the light receiving part is compared with the reference value that is predetermined in the control device 200 (S240).

When the light-quantity signal measured through the light receiving part is larger than the reference value that is predetermined in the control device 200, the switch 130 maintains an ON state such that the LED2 member 110b functions as the light emitting part (S210). When the light-quantity signal measured through the light receiving part is smaller than the reference value that is predetermined in the control device 200, an alarm informing of a failure is made (S250).

After the alarm informing of the failure of the LED2 member 110b is made, the light-quantity signal corresponding to the sum of the light quantities of the LED1 member 110a and the LED2 member 110b is compared with the predetermined reference value (S310). When the light-quantity signal obtained by summing the light quantities of the LED1 member and the LED 2 device (all LED members in the LED package 100) is equal to or more than the predetermined reference value, the switch 130 is controlled such that the LED1 member and the LED 2 device emit light (S320).

the control device 200 may form the light emitting part including a plurality of LED members to have a light-quantity signal that is equal to or more than the predetermined reference value in the control device.

In contrast, when the light-quantity signal obtained by summing the light quantities of the LED1 member and the LED 2 device (all LED members in the LED package 100) is less than the predetermined reference value, the alarm informing of the failure is made (S330) and logic is terminated.

The present invention may obtain the following effects by the configuration, combination and use of the above embodiments.

Various aspects of the present invention are directed to providing an effect that is capable of increasing a service life while maintaining high-efficiency working conditions of an LED package.

Furthermore, various aspects of the present invention are directed to providing a compensation system that is configured to continuously maintain the function of an individual LED device of an LED package, thus maintaining the function of the LED package in spite of the failure of the individual LED device.

Further, various aspects of the present invention are directed to providing an LED package, which is capable of continuously maintaining light emitting performance to satisfy a user's demand.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An LED compensation system including:
an LED device including a plurality of LED members to which an electric current is supplied from a power source;
a switch located between the power source and the LED device to selectively supply the electric current to each of the LED members; and
a control device configured to control an operation of the LED device,
wherein at least one LED member of the LED device is configured to be operated as a light emitting part, and at least one of remaining LED members is configured to be operated as a light receiving part,
the light receiving part measures a quantity of light generated from the light emitting part and transmits a light-quantity signal to the control device, and the control device is configured to compare the measured light-quantity signal with a predetermined reference value, and
the control device performs control to convert at least one LED member that is not used as the light emitting part into the light emitting part, when the light-quantity signal measured by the light receiving part is smaller than the predetermined reference value.

2. The LED compensation system of claim 1, wherein the control device comprise an analog processing integrated circuit and an micro controller unit (MCU),
the analog processing integrated circuit controls an operation of the LED device in response to the light-quantity signal measured by the light receiving part, and
the MCU is connected to the analog processing integrated circuit to compare the light-quantity signal received by the light receiving part with the predetermined reference value and transmit an operation control command of the LED device to the analog processing integrated circuit.

3. The LED compensation system of claim 2, wherein the MCU controls opening or closing of the switch to convert an LED member that is not used as the light emitting part into the light emitting part, when the measured light-quantity signal is smaller than the predetermined reference value.

4. The LED compensation system of claim 1, wherein the light-quantity signal measured by the light receiving part is determined by a difference between a voltage applied from the power source and a voltage used in the LED member used as the light emitting part.

5. The LED compensation system of claim 1, wherein the control device converts the LED member used as the light emitting part into the light receiving part, when the light-quantity signal measured by the light receiving part is smaller than the predetermined reference value.

6. The LED compensation system of claim 1, wherein, when two or more LED members form the light emitting part, a sum of light-quantity signals generated by the plurality of LED members constituting the light emitting part is compared with the predetermined reference value.

7. The LED compensation system of claim 1, wherein, when each of LED members constituting the LED device has a light-quantity signal that is smaller than the predetermined reference value in the control device, the light emitting part includes a plurality of LED members to have a light-quantity signal that is equal to or larger than the predetermined reference value.

8. The LED compensation system of claim 1, further including:
a cover device provided on a top portion of the LED device to perform uniform scattering.

9. The LED compensation system of claim 8, wherein the cover device has a dome shape.

10. A method of controlling an LED compensation system, comprising:
a) measuring a quantity of light generated from at least one LED member among a plurality of LED members that is driven as a light emitting part, in the LED device driven as a light receiving part;
b) comparing a measured light-quantity signal with a predetermined reference value in a control device; and
c) converting at least one LED member that is not used as the light emitting part into the light emitting part, when the light-quantity signal measured at b) is smaller than the predetermined reference value in the control device.

11. The method of claim 10, wherein, at a), the light-quantity signal measured in the light receiving part is equal to a difference between a voltage applied from a power source and a voltage used in the LED member used as the light emitting part.

12. The method of claim 10, wherein, at c), the converting includes controlling opening or closing of a switch connected to each of the LED members, and converting at least one LED member that is not used as the light emitting part into the light emitting part.

13. The method of claim 10, wherein, at c), the converting further includes using the LED member that is used as the light emitting part, as the light receiving part.

14. The method of claim 10, wherein, at a), when at least two LED members are used as the light emitting part, a sum of light-quantity signals generated by at least two LED members constituting the light emitting part is compared with the predetermined reference value.

15. The method of claim 10, wherein, at c), when each of the LED members has a light-quantity signal that is smaller than the predetermined reference value in the control device, a plurality of LED members is provided to have a light-quantity signal that is equal to or larger than the predetermined reference value, thus constituting the light emitting part.
